(19) United States
(12) Patent Application Publication
(10) Pub. No.: US 2011/0001380 A1
(43) Pub. Date: Jan. 6, 2011

(54) PERMANENT MAGNET AND ROTATING BEARING HAVING SUCH PERMANENT MAGNETS

(75) Inventors: Harald Erlinghagen, Feldkirchen-Westerham (DE); Walther Krug, Neufinsing (DE)

Correspondence Address: Muncy, Geissler, Olds & Lowe, PLLC, 4000 Legato Road, Suite 310, FAIRFAX, VA, 22033, US

(73) Assignee: Mad Magnetic Drive AG, Schaan (LI)

(21) Appl. No.: 12/918,348

(22) PCT Filed: Feb. 11, 2009
(86) PCT No.: PCT/EP2009/051520

§ 371 Date: Aug. 19, 2010

(30) Foreign Application Priority Data
Feb. 19, 2008 (DE) 10 2008 009 734.9

(51) Int. Cl. H02K 7/09; H01F 7/02

(52) U.S. Cl. 310/90.5; 335/302

(57) ABSTRACT

A permanent magnet (5, 11, 13) having a magnetic body made of a permanent magnetic material has a magnetic north and a magnetic south, wherein said magnetic body has a first pole surface (14) and a second pole surface on opposite ends having a lateral surface between them and a sheath (6, 7, 10, 12) made of a ferromagnetic material, which encloses the magnetic body with the exception of a subarea in the area of said first pole surface.

The invention relates to a permanent magnet as claimed in claim 1, and to a magnetic rotating bearing as claimed in claim 23, having a plurality of such permanent magnets.

Rotating bearings and permanent magnets which are suitable for this purpose are known, for example, from DE 20 2005 020 288 U1, which discloses a permanent-magnet contactless radial rotating coupling which has, arranged coaxially, a radially inner member and a radially outer member, each of which is provided with sets of magnets. The magnets in the inner radial member are each coupled in pairs by the magnetic attraction force to the magnets in the outer radial member, in order to transmit a torque between them.

DE 299 22 073 U1 discloses a contactless magnetic bearing system having a concave structure and a convex structure which are magnetized with the same polarity and are fitted very close to one another, or are plugged one into the other, but which act mechanically counter to one another by means of the magnetic field, and therefore do not come into contact with one another.

Large radial bearings in particular, that is to say bearings with a diameter of for example more than 500 mm, are frequently used in construction machines which operate in particularly severe conditions. This relates to the degree of load, to the dirt, to the maintenance and repair and to the life thereof. Rolling bearings with high prestresses and correspondingly high friction forces are used in this field.

The bearing according to the invention having permanent magnets is intended to minimize these problems.

This object is achieved by implementation of the characterizing features of the independent claims. Features which develop the invention in an alternative or advantageous manner can be found in the dependent patent claims.

According to the invention, a permanent magnet having a magnet body is formed from a permanently magnetic material, which has a north pole and a south pole, wherein the magnet body has a first pole surface and a second pole surface at opposite ends with an envelope surface in between. The magnet body is surrounded by a sheath composed of a ferromagnetic material, with the exception of a subarea in the area of the first pole surface. In particular, the sheath partially covers the first pole surface such that a free pole surface remains which is not covered by the sheath.

A first plurality of such permanent magnets can be used in a rotating bearing according to the invention, which are arranged on the outside on an inner ring, aligned radially with the free pole surface. In addition, a second plurality of such permanent magnets are arranged on the inside on an outer ring, aligned radially with the free pole surface. In this case, the inner ring and outer ring are arranged concentrically with respect to one another and the permanent magnets on the inner ring are arranged such that the free pole surfaces of two directly adjacent permanent magnets are not directly opposite one another, wherein the permanent magnets on the outer ring are arranged such that the free pole surfaces of two directly adjacent permanent magnets are not directly opposite one another, and wherein the free pole surface and the sheathed first pole surface of a permanent magnet in the inner ring which is directly opposite a permanent magnet in the outer ring are arranged with point symmetry with respect to one another.

The invention will be explained with reference to one exemplary embodiment, which is illustrated in the drawing, in which:

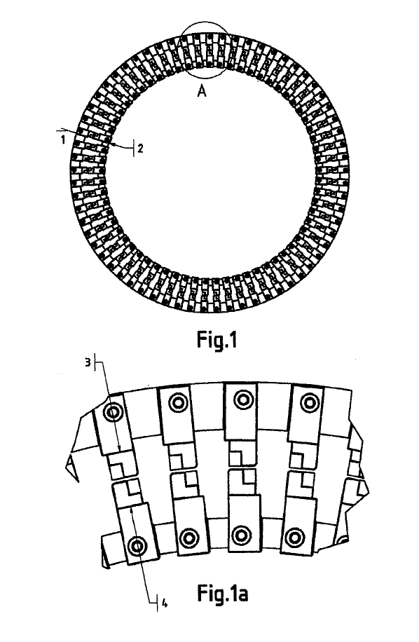

FIG. 1 shows a rotating bearing with an outer ring and inner ring;

FIG. 1a shows a section view of the rotating bearing;

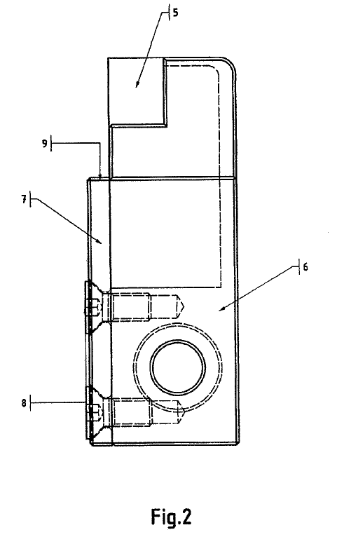

FIG. 2 shows an assembled functional unit consisting of the bar magnet 5 and the housing parts 6, 7;

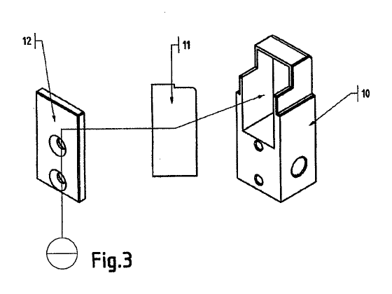

FIG. 3 shows the individual parts 10, 11, 12 of the functional unit;

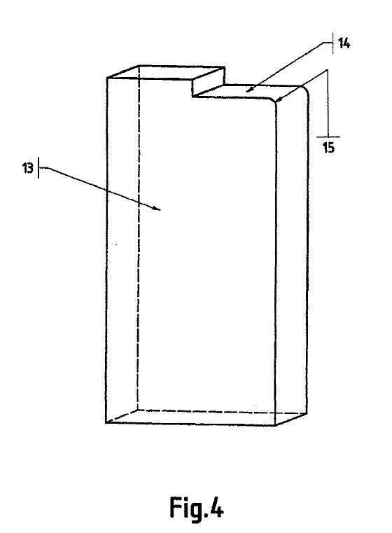

FIG. 4 shows a bar magnet with an offset on the pole surface;

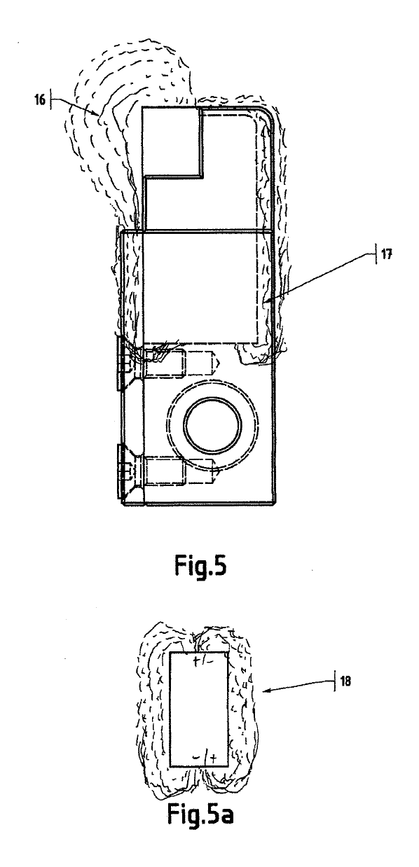

FIG. 5 shows the unipolar principle of operation;

FIG. 5a shows the normal magnetic field, and

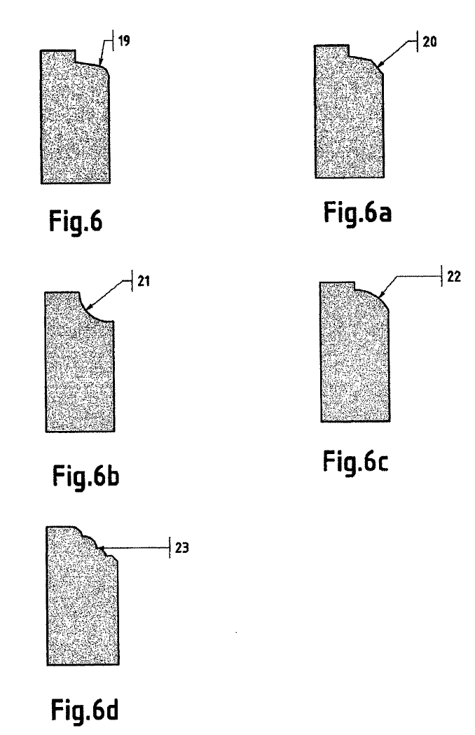

FIGS. 6-6d show various bar magnet geometries in the area of the pole surface plus/minus.

The invention has made it possible to adjust permanent magnetic fields such that a different magnetic field acts on a pole surface—positive or negative pole. It is thus possible for a difference force to be created between entry into the active field and exit from the active field. This difference force is desirable in order to achieve a preferred direction in the rotation direction as shown in FIGS. 1, 1a for a magnetic bearing.

The magnet units 3, 4 with the same polarity are arranged in an outer ring 1 and in an inner ring 2 in such a way that the adjusted surfaces of the magnet units are first moved into one another in the rotation direction. The difference force within the pole surface produces a preferred direction. A natural rotation block or return-movement block is produced in the opposite direction to the rotation sense—the preferred direction.

The individual permanent magnets can in this case be arranged at the same distance from one another in the circumferential direction on the inner ring 2 and on the outer ring 1, wherein the number of permanent magnets in the inner ring 2 can be equal to or not equal to the number of permanent magnets in the outer ring 1. The permanent magnets can also be arranged at an acute angle to the radial direction of the inner ring and outer ring.

This force is substantially dependent on the entry angle and exit angle of the two magnet systems 3, 4 with respect to one another and on the adjustment of the magnetic field guidance illustrated in FIG. 5. A further factor is the preset gap size, which is set between the two open magnetic fields 16 and must be calculated as a function of the dynamic torque and the rotation speed.

Use is intended for large radial bearings with permanent magnets, for example as illustrated in FIG. 1, with diameters of more than 500 mm up to a maximum revolution speed of 50 rpm. Roller bearings with high prestresses and correspondingly high friction forces are otherwise used in this range.

In contrast to conventional bearings, the magnetic bearing according to the invention, which is purely contactless, is distinguished by having no friction forces whatsoever. There are no losses whatsoever in the transmitted torque in the rotation direction. The bearing is completely maintenance-free and is not susceptible to normal dirt. No environmentally hazardous greases or oils can emerge, since there are none. If desirable or required, the life of a bearing such as this can be designed for more than 700,000 operating hours. Furthermore, there is a cost advantage over conventional roller bearings of the same size.

This bearing can be used in machines for above ground or below ground installation and in all applications which have to comply with particular requirements relating to the environmental variables (clean-room conditions).

In order to adjust the magnetic field, the magnet 13 illustrated by way of example in FIG. 4 is sheathed with a geometrically specially machined housing 10, 12 composed of ferromagnetic material. This material is provided with very specific physical characteristics. Essentially, these are magnetically high-permeability materials which are in very pure form or are in the form of alloys. The special physical characteristics of the material comprise a very high magnetic saturation induction of ≧2 Tesla, a very low coercivity field strength and remanence, and a high permeability. In this case, the sheath may have a magnetic saturation greater than 1.2 Tesla, and preferably in the range between 1.3 and 2.5 Tesla. The material for the sheath 6, 7, 10, 12 may be pure iron or an alloy with pure iron.

This body 17 is illustrated together with the associated magnetic field guidance in FIG. 5 and is machined such that, either by means of a chamfer or a rounded area, it represents the transition on the entry side from the upright wall to the horizontal wall—resting directly on the pole of the magnet—as a closed body. In the area 9 from which the permanent magnetic field changes from positive to negative, the body is closed on all sides and is designed with such a high mass—material—that the magnetic field in the area of the pole is approximately neutral <10 mT.

In order to make it possible to fully exploit the high induction of the material, all the surfaces between the magnet and the material guide must be machined very finely and must make complete contact.

The most important surface of the system is the pole surface 14, 15 shown in FIG. 4, and its geometric design. This relates both to the magnetic field guide body 17, see FIG. 5, and to the bar magnet shown in FIG. 4.

The bar magnet illustrated in FIG. 4 is held in its base body such that the greatest possible volume product=greatest possible magnetic field is maintained. In the area of the adjusted magnetic field on the pole surface=active surface 14, the magnet is provided with an offset on the pole surface. Irrespective of whether the shape of the pole surface of the magnet is round or polygonal, the height of this offset can be designed such that the polarity of the offset in the new pole surface is the same as the unmachined surface. In order to optimize the magnetic field guidance, the offset step can be designed with an appropriate radius 15 or with other geometries, cf. FIGS. 6-6d.

According to the invention, the magnet bodies may have various geometries, for example may be in the form of a bar, in the form of a disk, or polygonal. The cross section may in this case, for example, be rectangular, triangular or trapezoidal. The continuous end surface is preferably planar.

In one exemplary embodiment, the first pole surface 14 has a step with an upper step surface, a lower step surface and a step transition surface which is arranged between the upper and the lower end surfaces, wherein the upper step surface is formed by the free pole surface.

The transition between the step transition surface and the lower step surface can be designed such that it has an angled cross section. In addition, the transition between the lower step surface and the envelope surface can be inclined or rounded, at least on the side of the lower step surface 19, 20 opposite the transition surface.

In another exemplary embodiment, the transition between the lower step surface 21 and the envelope surface is concave, at least on the side of the lower step surface opposite the transition surface.

The transition between the lower step surface 23 and the envelope surface may be inclined or rounded or both, at least on the side of the lower step surface opposite the transition surface.

The pole cover surface of the housing in the area of the offset can be designed such that the thickness of the wall of the cover results in an equilibrium between the attraction force of the housing envelope in the area of the active surface and the remaining repulsion force of the residual magnetic field—over the cover surface shown in FIG. 5—as a unipolar operating principle—as a function of the permanent magnetic field magnetization strength—the residual field between the remaining magnetic field—and the attraction force—the adhesion force of the magnetic field guide housing—volume housing mass between two opposite active functional units 3, 4.

If this adjustment is carried out correctly two permanent magnetic fields of the same polarity which are positioned operatively opposite one another can be moved into one another with less force being applied than would be possible with a pair of magnets of the same polarity repelling one another, without this special adjustment. This results in a difference which can be determined precisely within the supporting field=repulsion magnetic force of the magnetic bearing, thus making it possible to define a preferred direction in the rotation direction, and allowing this to be adjusted by measurement.

The side walls of the magnetic field guide body can be designed such that a corresponding residual magnetic field is created of the same polarity as the active surface. This wall thickness can be designed in such a way up to the zone of the reversal point of the magnetic field 9. The surface of the side wall unlatches in the rotation direction within the side wall. This additionally supports the preferred direction.

In the area of the pole reversal of the bar magnet 9, the magnetic field guidance is closed completely in a body, as shown in FIG. 5. The wall thickness is increased such that a magnetically neutral field <10 mT is created on the outer surface of the body.

The active magnetic field is neutral at a distance of about 8 mm from the housing wall.

The bottom of the housing 6 is designed to be sufficiently thick that the magnetic field is neutralized, and all of the holes or other types of attachment required for attachment and assembly of the magnet system are contained, and there is no influence on the actual operation.

The closure cover 7, 12 is composed of the same material as the magnetic field guide bodies 6, 10. The cover ends in the area of the reversal point 9 of the magnetic field. The size and the type of attachment of the closure cover are illustrated in FIG. 2.

The principle of operation is explained in FIG. 2. The functional unit generates a monopolar magnetic field whose direction of action and field strength can be adjusted accurately. Because of the special form of the magnetic field guide body, the original magnetic field 18 is maintained only in the free open pole surface 16 and therefore in a precisely definable direction of operation. The remaining magnetic field is bent, guided and fully maintained at 17 within the wall of the magnetic field guide body 6, 7 in such a way that the stability of the overall magnetic field is not changed or weakened. This is a precondition for the operation of the magnet and of the magnetic field.

In this case, the subarea without a sheath may be between 4% and 40% of the surface of the magnet body. According to the invention, it is possible for the sheath 10 to be thinner in the area of the first pole surface 14 than in the rest of the area.

The sheath 10 can also be designed such that it extends beyond the second pole surface and is in the form of an attachment device for the permanent magnet.

In one exemplary embodiment, the first pole surface of the magnetic body has a profile whose cross section is not a straight line, and the sheath 10, which partially covers the first pole surface 14, and the free pole surface form a continuous end surface, in which the end surface may be planar. The sheath 10 can in this case partially cover the first pole surface 14 such that a free pole surface remains which is not covered by the sheath. Furthermore, the sheath 10 can be thinner in the area of the first pole surface 14 than in the rest of the area.

In a further development of this exemplary embodiment, the first pole surface 14 may have a step with an upper step surface, a lower step surface and a step transition surface which is arranged between the upper and the lower end surfaces, and the upper step surface may be formed by the free pole surface. In this case, the transition between the step transition surface and the lower step surface may have an angled cross section.

The transition between the free pole surface and the step transition surface may also have an angled cross section, in particular a right-angled cross section.

Eddy current fields: In the area of the housing base, that is to say in the closed housing 6, 7, the magnetic field guidance and wall thickness can be made sufficiently great, as a function of the magnetization strength, that the magnetic field is kept completely in the material and has a magnetically neutral profile on the outside. This ensures that no disturbing alternating fields or compressed eddy current fields are created, which can influence the operation of the magnetic bearing.

Furthermore, this design allows all the important construction materials to be used in the area of the static construction of the bearing without any risk of them being influenced by the permanent magnetic field.

1-26. (canceled)

27. A permanent magnet having a magnet body composed of a permanently magnetic material, which has a north pole and a south pole, wherein the magnet body has a first pole surface and a second pole surface at opposite ends with an envelope surface in between, and having a sheath composed of a ferromagnetic material, which surrounds the magnet body with the exception of a subarea in the area of the first pole surface, wherein the sheath partially covers the first pole surface such that a free pole surface remains which is not covered by the sheath.

28. The permanent magnet as claimed in claim 27, wherein the sheath has a magnetic saturation greater than 1.2 Tesla, and preferably in the range between 1.3 and 2.5 Tesla.

29. The permanent magnet as claimed in claim 27, wherein the sheath is composed of pure iron.

30. The permanent magnet as claimed in claim 27, wherein the sheath is composed of an alloy with pure iron.

31. The permanent magnet as claimed in claim 27, wherein the subarea without a sheath is between 4% and 40% of the surface of the magnet body.

32. The permanent magnet as claimed in claim 27, wherein the magnet body is in the form of a bar.

33. The permanent magnet as claimed in claim 27, wherein the magnet body is in the form of a disk or is polygonal.

34. The permanent magnet as claimed in claim 27, wherein the sheath is thinner in the area of the first pole surface than in the rest of the area.

35. The permanent magnet as claimed in claim 27, wherein the first pole surface of the magnet body has a cross section with a profile which is not a straight line, and wherein the sheath, which partially covers the first pole surface, and the free pole surface form a continuous end surface.

36. The permanent magnet as claimed in claim 35, wherein the continuous end surface is planar.

37. The permanent magnet as claimed in claim 35, wherein the first pole surface has a step with an upper step surface, a lower step surface and a step transition surface which is arranged between the upper and the lower end surfaces, and wherein the upper step surface is formed by the free pole surface.

38. The permanent magnet as claimed in claim 37, wherein the transition between the step transition surface and the lower step surface has an angled cross section.

39. The permanent magnet as claimed in claim 37, wherein the transition between the free pole surface and the step transition surface has an angled cross section, in particular a right-angled cross section.

40. The permanent magnet as claimed in claim 35, wherein the transition between the lower step surface and the envelope surface is inclined or rounded, at least on the side of the lower step surface opposite the transition surface.

41. The permanent magnet as claimed in claim 27, wherein the magnet body has a rectangular cross section.

42. The permanent magnet as claimed in claim 27, wherein the magnet body has a triangular cross section.

43. The permanent magnet as claimed in claim 27, wherein the magnet body has a trapezoidal cross section.

44. The permanent magnet as claimed in claim 27, wherein the sheath extends beyond the second pole surface and is in the form of an attachment device for the permanent magnet.

45. The permanent magnet as claimed in claim 27, wherein the transition between the lower step surface and the envelope surface is concave, at least on the side of the lower step surface opposite the transition surface.

46. The permanent magnet as claimed in claim 27, wherein the transition between the lower step surface and the envelope surface is convex, at least on the side of the lower step surface opposite the transition surface.

47. The permanent magnet as claimed in claim 27, wherein the transition between the lower step surface and the envelope surface is inclined or rounded or both, at least on the side of the lower step surface opposite the transition surface.

48. A rotating bearing having a first plurality of permanent magnets as claimed in claim 27, which are arranged on an inner ring, aligned radially with the free pole surface toward the outside, further comprising:
a second plurality of permanent magnets, which are arranged on an outer ring, aligned radially with the free pole surface towards the inside;
wherein the inner ring and outer ring are arranged concentrically with respect to one another;
wherein the permanent magnets on the inner ring are arranged such that the free pole surfaces of two directly adjacent permanent magnets are not directly opposite one another;
wherein the permanent magnets on the outer ring are arranged such that the free pole surfaces of two directly adjacent permanent magnets are not directly opposite one another; and
wherein the free pole surface and the sheathed first pole surface of a permanent magnet in the inner ring which is directly opposite a permanent magnet in the outer ring is arranged with point symmetry with respect to the permanent magnet in the outer ring.

49. The rotating bearing as claimed in claim 48, wherein the individual permanent magnets on the inner ring and on the outer ring are arranged at the same distance from one another in the circumferential direction.

50. The rotating bearing as claimed in claim 48, wherein the number of permanent magnets in the inner ring is equal to the number of permanent magnets in the outer ring.

51. The rotating bearing as claimed in claim 48, wherein the number of permanent magnets in the inner ring is not equal to the number of permanent magnets in the outer ring.

52. The rotating bearing as claimed in claim 48, wherein the permanent magnets are arranged at an acute angle to the radial direction of the inner ring and outer ring.
